(19) United States
(12) Patent Application Publication
(10) Pub. No.: US 2025/0134623 A1
(43) Pub. Date: May 1, 2025

(54) DEVICE AND METHOD FOR PLACEMENT OF DENTAL RESTORATIONS

(71) Applicant: AdDent, Inc., Danbury, CT (US)

(72) Inventor: Joshua Friedman, Boulder, CO (US)

(73) Assignee: AdDent, Inc., Danbury, CT (US)

(21) Appl. No.: 18/927,529

(22) Filed: Oct. 25, 2024

Related U.S. Application Data
(60) Provisional application No. 63/593,071, filed on Oct. 25, 2023.

(51) Int. Cl. A61C 3/00

(52) U.S. Cl. CPC A61C 3/00

(57) ABSTRACT

A device for holding small objects used in dentistry is disclosed. The device is suitable for use to hold a dental veneer, inlay, onlay, or crown before and during placement. In some implementations, the device includes a handle and at least one removable suction tip attached thereto that can adhere to small objects. In other implementations, the device includes a handle and at least one removable restoration carrier tip attached thereto. The handle may be an independent component that is configured to have one or two removable suction tips or restoration carrier tips attached thereto or may alternatively be part of a curing light. The device is composed of a clear or translucent soft material with a Shore A durometer hardness of between about 30 and about 50. The device allows a user to polymerize a light curable adhesive through the body of the removable tip or restoration carrier tip.

### BACKGROUND

### Field of the Invention

The present disclosure relates to dental veneers, inlays, onlays, and crowns.

### Description of the Related Art

Veneers are commonly used in dental restorative procedures for anterior teeth. A veneer is typically placed on the labial surface of a tooth following removal of some of the enamel. A veneer may be made from porcelain or a composite material. It is usually 1-2 mm thick, fragile, and difficult to place in the proper position. The cementation procedure for a veneer consists of four main steps: preparation of the surface of the enamel, placement of a composite cement on the inner surface of the veneer, adhesion of the cement to the surface of the enamel, and polymerization of the composite cement using a light curing device following its adhesion to the surface of the enamel to permanently secure the veneer to the tooth.

Because handling a thin veneer is difficult, especially while the dentist is wearing surgical gloves, the dental industry has produced several devices for handling veneers. Currently available products for handling veneers include devices available under the names Pic-N-Stic™, OptraStick™, Micro-Stix™, and LumiGrip®.

The Pic-N-Stic™, OptraStick™, and Micro-Stix™ devices are composed of a plastic handle with a waxlike adhesive adhered to one end. The adhesive is used to pick up a veneer and place it onto a tooth. Once the veneer is placed in its desired location, the device must be removed prior to polymerization of the composite cement that will adhere the veneer to the tooth, or else the device will prevent the light from the curing light from reaching the composite cement and thereby prevent polymerization from occurring. Removal of the device may lead to shifting of the veneer from its desired position unless it is separately held in place.

The LumiGrip® device consists of a tip and a handle with a hose connected to a source of suction. This device needs to be taken apart for sterilization following use and can only be used where a vacuum suction connection is available. The LumiGrip® device is an expensive product and is not suitable for use in all dental practices.

There remains a need for a device for use in placement of dental veneers and other small dental restorations that overcomes the shortcomings of currently available devices used for this purpose.

### SUMMARY

A device for holding small objects used in dentistry is disclosed herein. The device is suitable for use to hold a dental veneer, inlay, onlay, or crown before and during placement.

In some implementations, the device includes a handle and at least one removable suction tip attached thereto that can adhere to small objects. In some other implementations, the device includes a handle and at least one removable restoration carrier tip attached thereto. The handle may be an independent component that is configured to have one or two removable suction tips or restoration carrier tips attached thereto or may alternatively be part of a curing light. The device is composed of a clear or translucent soft material with a Shore A durometer hardness of between about 30 and about 50. The device allows a user to polymerize a light curable adhesive through the body of the removable suction tip or restoration carrier tip.

In some implementations, the device may be used to carry, place, and cement a porcelain dental veneer, and then light cure the cement while the veneer is placed under pressure. In such implementations, the device includes a transparent or translucent suction tip that is used to secure a dental veneer.

In some implementations, the device may be used to carry, place, and cement a porcelain posterior restoration such as an inlay, onlay, or crown, and then light cure the cement while the restoration is placed under pressure. In such implementations, the device includes a transparent or translucent restoration carrier tip that is used to hold a small amount of uncured silicone or other clear moldable gel material. The silicone or other gel material temporarily adheres to the restoration so that it may be placed in the desired position.

The handle may be composed of metal or a polymer. In some embodiments, the polymer may be an autoclavable polymer, such as polysulfone. The removable suction tip or restoration carrier tip may be adjusted to fit onto the handle in multiple positions. The suction tip or restoration carrier tip may be composed of a thermoplastic elastomer (TPE) or silicone with a Shore A durometer hardness of between about 30 and about 50. Because the suction tip or restoration carrier tip is clear or translucent, it can be held in place while light curing of the composite cement occurs therethrough, thereby preventing the veneer, inlay, onlay, or crown from shifting from its desired position prior to curing.

### BRIEF DESCRIPTION OF THE DRAWINGS

The figures provided herewith are intended to illustrate but not to limit the invention. Reference numbers are reused in the figures to indicate correspondence between referenced elements.

FIG. 1 shows an embodiment of the handle with suction tips.

FIG. 2 shows an embodiment of the handle with a suction tip and a veneer attached to the tip.

FIG. 3 shows an embodiment of the handle, vacuum tip, and a veneer placed on an upper anterior tooth.

FIG. 4 shows an example of a veneer being placed on a lower anterior tooth using an embodiment of the disclosed device.

FIG. 5 shows an example of a veneer being polymerized in place with a curing light.

FIG. 6 shows an embodiment where the handle is the light guide of a curing light and a suction tip is attached thereto.

FIG. 7 shows an embodiment of the device having a restoration carrier tip holding a gel, where the device is carrying an inlay prior to placement.

FIG. 8 shows the embodiment of the device shown in FIG. 7 securing a restoration that is being placed under pressure.

### DETAILED DESCRIPTION

A device for holding small objects used in dentistry is disclosed herein. The device is suitable for use to hold a dental veneer, inlay, onlay, or crown before and during placement.

In some implementations, the device includes a handle and at least one removable suction tip attached thereto that can adhere to small objects. In some other implementations, the device includes a handle and at least one removable restoration carrier tip attached thereto. The handle may be an independent component that is configured to have one or two removable suction tips or restoration carrier tips attached thereto or may alternatively be part of a curing light. The device is composed of a clear or translucent soft material with a Shore A durometer hardness of between about 30 and about 50. The device allows a user to polymerize a light curable adhesive through the body of the removable suction tip or restoration carrier tip.

In some implementations, the device may be used to carry, place, and cement a porcelain dental veneer, and then light cure the cement while the veneer is placed under pressure. In such implementations, the device includes a transparent or translucent suction tip that is used to secure a dental veneer.

In some implementations, the device may be used to carry, place, and cement a porcelain posterior restoration such as an inlay, onlay, or crown, and then light cure the cement while the restoration is placed under pressure. In such implementations, the device includes a transparent or translucent restoration carrier tip that is used to hold a small amount of uncured silicone or other clear moldable gel material. The silicone or other gel material temporarily adheres to the restoration so that it may be placed in the desired position.

The handle may be composed of metal or a polymer. In some embodiments, the polymer may be an autoclavable polymer, such as polysulfone. The removable suction tip or restoration carrier tip may be adjusted to fit onto the handle in multiple positions. The suction tip or restoration carrier tip may be composed of a thermoplastic elastomer (TPE) or silicone with a Shore A durometer hardness of between about 30 and about 50. Because the suction tip or restoration carrier tip is clear or translucent, it can be held in place while light curing of the composite cement occurs therethrough, thereby preventing the veneer, inlay, onlay, or crown from shifting from its desired position prior to curing.

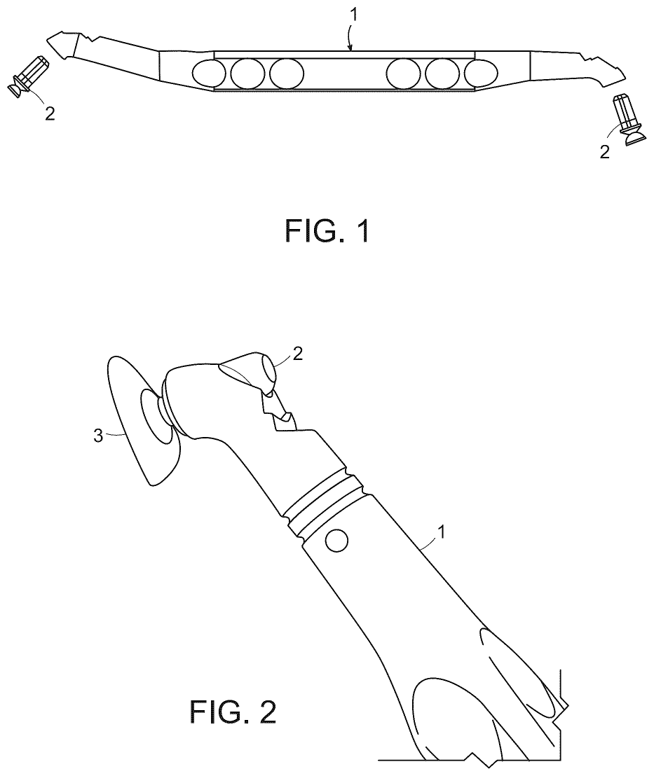

FIG. 1 shows a perspective view of the embodiment of the disclosed device, including a handle 1 and suction tips 2. Suction tips 2 may be available in multiple sizes. For example, the device may include a large suction tip having a diameter in the 4-7 mm range and a small suction tip having a diameter in the 3-4 mm range. The small suction tip may be used, for example, for lower arch anterior veneers. An extra-large suction tip having a diameter in the 7-10 mm range may additionally or alternatively be available.

FIG. 2 shows an embodiment of the handle 1 with a suction tip 2 assembly holding a porcelain veneer restoration 3.

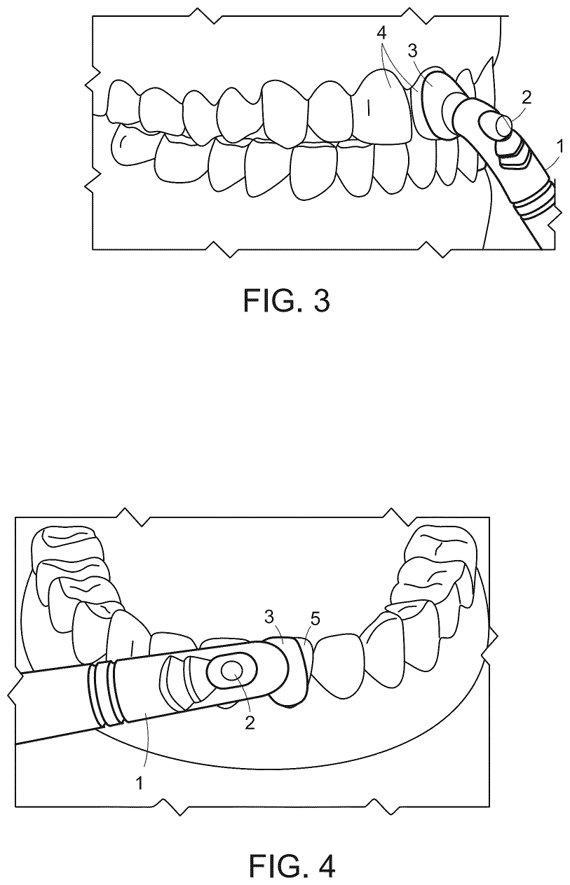

FIG. 3 shows an example of the suction tip 2 holding a porcelain veneer 3 and applying it to an upper tooth 4.

FIG. 4 shows an example of the suction tip 2 holding a porcelain veneer 3 and applying it to a lower tooth 5.

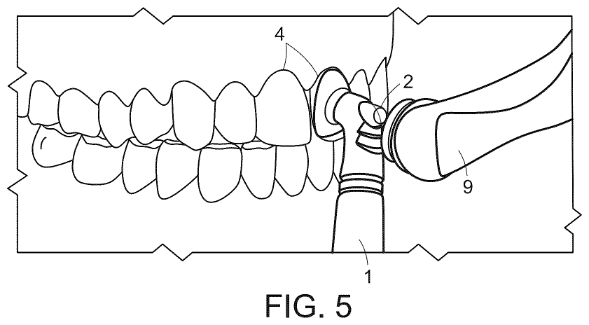

FIG. 5 shows an embodiment of the disclosed device, including the handle 1 and a suction tip 2, being used to place a veneer restoration 3 on a tooth 4 in preparation for light curing. The curing light 9 is briefly placed on the vacuum tip. Once partial polymerization often termed a tack cure-is completed, the suction tip 2 is removed from the tooth and the excess cement is removed from the margins of the veneer 3. After excess cement is removed from the margins, a curing light is used to complete the polymerization of the cement without the tip holding the veneer in place.

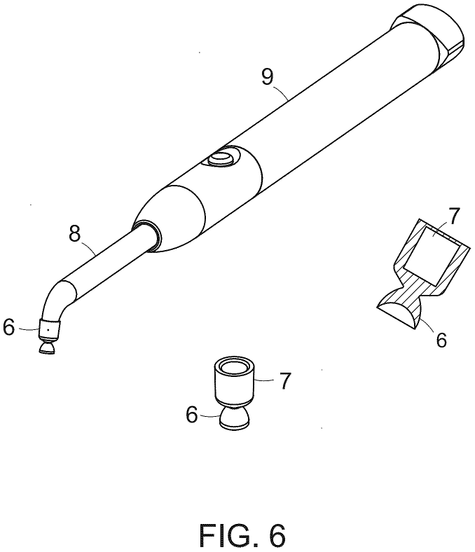

FIG. 6 shows an embodiment of the disclosed device having a modified suction tip 6 that attaches to a light guide 8 of a curing light 9 via an open end 7. When using this type of transparent tip, the veneer is held in place in a similar way as shown in FIG. 3. However, in this embodiment, the tack curing of the veneer is performed without the need for a handle that is separate from the curing light as shown in FIGS. 1 and 2, as the curing light itself replaces the handle.

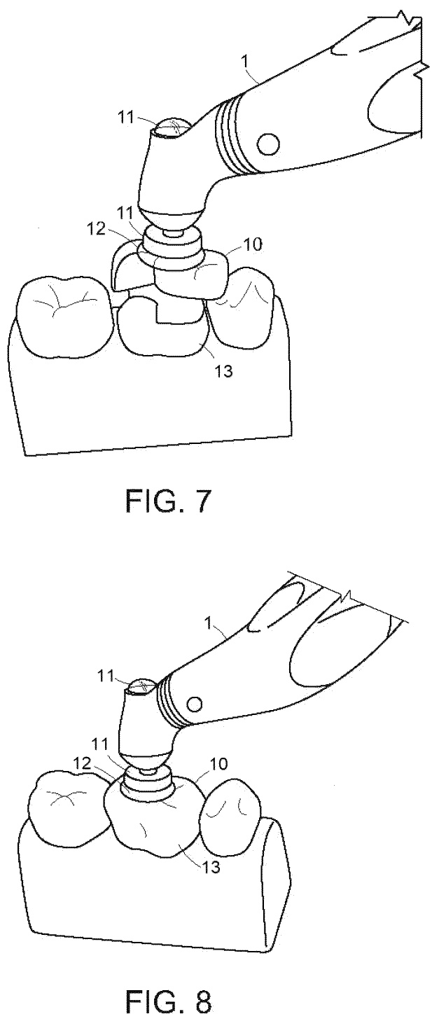

FIG. 7 shows an embodiment of the disclosed device carrying a posterior porcelain inlay 10 to a prepared tooth. A handle 1 holds a transparent or translucent restoration carrier tip 11. The restoration carrier tip 11 holds a gel 12 composed of uncured silicone or another transparent moldable material. The gel 12 temporarily adheres to the porcelain inlay 10 and carries it to the tooth 13.

FIG. 8 shows the embodiment of the disclosed device shown in FIG. 7 holding the porcelain inlay 10 under pressure to be cured, thereby ensuring that the inlay 10 is properly positioned on the prepared tooth 13.

A method of polymerizing a composite cement to secure a dental veneer into a desired position on a tooth is also disclosed herein. The disclosed method includes the following steps in order: (i) applying a composite cement to an interior side of a dental veneer, (ii) adhering a suction tip to an exterior side of the dental veneer, (iii) positioning the dental veneer on a tooth by contacting the composite cement on the interior side of the dental veneer with the tooth, (iv) polymerizing the composite cement to secure the dental veneer into a desired position, and (v) removing the suction tip from the dental veneer.

A method of polymerizing a composite cement to secure a porcelain posterior dental restoration into a desired position on a tooth is also disclosed herein. The disclosed method includes the following steps in order: (i) applying a composite cement to an interior side of a dental restoration, (ii) temporarily adhering a restoration carrier tip that has a gel placed therein to an exterior side of the dental restoration, (iii) positioning the dental restoration on a tooth by contacting the composite cement on the interior side of the dental restoration with the tooth, (iv) polymerizing the composite cement to secure the dental restoration into a desired position, and (v) removing the restoration carrier tip and the gel from the dental restoration. The dental restoration being secured may be a porcelain inlay, onlay, or crown.

A method of partially polymerizing a composite cement to secure a dental veneer into a desired position on a tooth is also disclosed herein. Partial polymerization of a composite cement is often termed tack curing. The disclosed method includes the following steps in order: (i) applying a composite cement to an interior side of a dental veneer, (ii) adhering a suction tip to an exterior side of the dental veneer, (iii) positioning the dental veneer on a tooth by contacting the composite cement on the interior side of the dental veneer with the tooth, (iv) partially polymerizing the composite cement to secure the dental veneer into a desired position, and (v) removing the suction tip from the dental veneer.

A method of partially polymerizing a composite cement to secure a porcelain posterior dental restoration into a desired position on a tooth is also disclosed herein. The disclosed method includes the following steps in order: (i) applying a composite cement to an interior side of a dental restoration, (ii) temporarily adhering a restoration carrier tip that has a gel placed therein to an exterior side of the dental restoration, (iii) positioning the dental restoration on a tooth by contacting the composite cement on the interior side of the dental restoration with the tooth, (iv) partially polymerizing the composite cement to secure the dental restoration into a desired position, and (v) removing the restoration carrier tip and the gel from the dental restoration. The dental restoration being secured may be a porcelain inlay, onlay, or crown.

Following tack curing of the dental veneer or posterior dental restoration, excess cement may be removed from the margins of the dental veneer or posterior dental restoration prior to further polymerization of the composite cement that permanently secures the dental veneer or posterior dental restoration to the tooth. Removal of composite cement prior to final curing makes removal of excess composite cement much easier.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

As used herein the terms “about” and “generally” when related to numerical values herein refers to known commercial and/or experimental measurement variations or tolerances for the referenced quantity. In some embodiments, such known commercial and/or experimental measurement tolerances are ±10% of the measured value, while in other embodiments such known commercial and/or experimental measurement tolerances are ±5% of the measured value, while in still other embodiments such known commercial and/or experimental measurement tolerances are ±2.5% of the measured value, and in still other embodiments, such known commercial and/or experimental measurement tolerances are ±1% of the measured value.

While the above detailed description has shown, described, and pointed out novel features as applied to various embodiments, it will be understood that various omissions, substitutions, and changes in the form and details of the devices or methods illustrated may be made without departing from the spirit of the disclosure. As will be recognized, certain embodiments of the inventions described herein may be embodied within a form that does not provide all of the features and benefits set forth herein, as some features may be used or practiced separately from others.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

All references cited are hereby expressly incorporated herein by reference.

What is claimed is:

1. A device for holding a dental veneer comprising:
a. at least one suction tip composed of a translucent or transparent material; and
b. a handle;
wherein the suction tip is removably attached to the handle, and
wherein the suction tip is capable of reversibly securing a dental veneer.

2. The device of claim 1, wherein the handle is configured to have one or two suction tips attached thereto.

3. The device of claim 1, wherein the handle is the light guide of a curing light.

4. The device of claim 1, wherein the suction tip is composed of a material having a Shore A durometer hardness of between about 30 and about 50.

5. The device of claim 3, wherein the suction tip is composed of a material having a Shore A durometer hardness of between about 30 and about 50.

6. The device of claim 1, wherein the handle is composed of an autoclavable polymer.

7. The device of claim 4, wherein the handle is composed of an autoclavable polymer.

8. The device of claim 5, wherein the handle is composed of an autoclavable polymer.

9. The device of claim 6, wherein the polymer is polysulfone.

10. The device of claim 7, wherein the polymer is polysulfone.

11. The device of claim 8, wherein the polymer is polysulfone.

12. A device for holding a posterior dental restoration comprising:
a. at least one restoration carrier tip composed of a translucent or transparent material; and
b. a handle;
wherein the restoration carrier tip is removably attached to the handle, and wherein the restoration carrier tip is capable of reversibly securing a posterior dental restoration.

13. The device of claim 12, wherein the handle is configured to have one or two restoration carrier tips attached thereto.

14. The device of claim 12, wherein the handle is the light guide of a curing light.

15. The device of claim 12, wherein the restoration carrier tip is composed of a material having a Shore A durometer hardness of between about 30 and about 50.

16. The device of claim 15, wherein the handle is composed of an autoclavable polymer.

17. The device of claim 16, wherein the polymer is polysulfone.

18. A method of partially polymerizing a composite cement to secure a dental veneer or posterior dental restoration into a desired position on a tooth comprising:
a. applying a composite cement to an interior side of a dental veneer or posterior dental restoration,
b. adhering a tip to an exterior side of the dental veneer or posterior dental restoration,
c. positioning the dental veneer or posterior dental restoration on a tooth by contacting the composite cement on the interior side of the dental veneer or posterior dental restoration with the tooth,
d. partially polymerizing the composite cement to secure the dental veneer or posterior dental restoration into a desired position, and
e. removing the tip from the dental veneer or posterior dental restoration.

19. The method of claim 18, wherein the tip is a suction tip, and wherein the suction tip is adhered to an exterior of a dental veneer in step (b).

20. The method of claim 18, wherein the tip is a restoration carrier tip, and wherein the restoration carrier tip is adhered to an exterior of a posterior dental restoration using a gel in step (b).
